(19) United States
(12) Patent Application Publication
(10) Pub. No.: US 2016/0370120 A1
(43) Pub. Date: Dec. 22, 2016

(54) MODULAR BONNET FOR VARIABLE-PASS HEAT EXCHANGER

(71) Applicant: Ingersoll-Rand Company, Davidson, NC (US)

(72) Inventors: Prathap Kumar Ramamoorthy, Bangalore (IN); David Keneda Harper, Concord, NC (US); Andrew David Nemcek, Davidson, NC (US)

(21) Appl. No.: 14/744,187

(22) Filed: Jun. 19, 2015

(51) Int. Cl. F28D 7/16; B23P 15/26

(52) U.S. Cl. CPC F28D 7/1669; B23P 15/26

(57) ABSTRACT

A shell and tube type heat exchanger is provided. The heat exchanger includes an elongated body defining therein a cavity that can receive a first fluid. An array of tubes having a first face and a second face can be configured within the cavity to direct a second fluid through the cavity. A bonnet can be functionally coupled to the array of tubes, the bonnet defining an interior region in fluidic communication with the array of tubes. A plate can be functionally coupled to the array of tubes, the plate defining a space in fluidic communication with the array of tubes. The bonnet can include one or more projections extending from an interior surface and into the interior region of the bonnet. The bonnet and plate are adaptable to define a first or second multi-pass flow pattern configuration of the second fluid within the array of tubes.

### BACKGROUND

Technical Field

The present disclosure relates to heat exchangers. More particularly, the disclosure relates to heat exchangers for the cooling of compressed fluids produced in compressors.

State of the Art

Fluid compressors are designed to mechanically force a fluid into a predetermined space to “compress” the fluid to thereby store or utilize the compressed fluid's potential energy. However, the laws of physics instruct that as a fluid is compressed, its temperature correspondingly rises. To address this issue, heat exchangers are often employed in the design and operation of fluid compressors to receive the compressed, heated fluid and reduce the temperature thereof.

Conventional shell and tube type heat exchangers, which are often referred to in this context as coolers or chillers, are utilized together with fluid compressors to achieve this desired heat transfer result. Normally, the shell portion, or outer casing, of the heat exchanger houses the cooling tubes therein and is configured to receive the compressed fluid. The cooling tubes, on the other hand, are positioned within the shell and are configured to receive the cooling fluid and direct the flow of cooling fluid within the shell. In operation, the cooling fluid flows through the shell via the tubes, and the compressed fluid flows over and around the tubes, which facilitates the transfer of heat away from the compressed fluid and into the cooling fluid.

Various multi-pass shell and tube type heat exchangers have been designed to transfer heat in this manner by routing the cooling fluid through one tube or set of tubes and thereafter reversing the direction of flow by routing the cooling fluid through another tube or set of tubes in the opposite direction within the shell. In this way, the heat from the compressed air is absorbed into the cooling fluid to thereby lower the temperature of the compressed fluid. The cooling fluid that has absorbed the heat of the compressed fluid is thereafter directed out of the shell, only to be replaced by fresher cooling fluid.

However, the various designs of shell and tube type exchangers can sometimes be influenced by, or even subjected to, regional (i.e., US, EMEA, AP, etc.) standards and guidelines for heat exchangers (i.e., air coolers). In particular, the parameters of cooling fluid flow rate, temperature and/or quality of the cooling fluid can impact design considerations and operational costs of the heat exchanger. As a result, different regions may oftentimes have different design specifications or run requirements for air coolers, which may lead to an assortment and/or a multiplicity of design implications. With a multitude of different designs for various heat exchangers, the costs of manufacture, operation and repair are multiplied.

It would therefore be advantageous to improve upon the configuration of shell and tube type heat exchangers (i.e., air coolers) to address the problems described above.

### SUMMARY

The present disclosure relates to heat exchangers, and in particular to a variable-pass heat exchanger in fluidic communication with a fluid compressor, the variable-pass heat exchanger being configured to cool the compressed fluid produced by operation of the compressor.

An aspect of the present disclosure includes a shell and tube heat exchanger comprising an elongated body defining therein a cavity, the elongated body configured to receive a first fluid into the cavity, an array of tubes configured within the cavity, the array of tubes having a first face and a second face, the array of tubes being configured to direct a second fluid through the cavity, a bonnet functionally coupled to the first face of the array of tubes, the bonnet defining an interior region in fluidic communication with the array of tubes, and a plate functionally coupled to the second face of the array of tubes, the plate defining a space in fluidic communication with the array of tubes, wherein the bonnet comprises projections extending therefrom within the interior region, the projections being adaptable to define a first or second multi-pass flow pattern configuration of the second fluid within the array of tubes.

Another aspect of the present disclosure includes wherein the array of tubes is detachably coupled to the elongated body.

Another aspect of the present disclosure includes wherein the bonnet is detachably coupled to the first face and the plate is detachably coupled to the second face.

Another aspect of the present disclosure includes wherein at least one of the projections is adaptable for length.

Another aspect of the present disclosure includes wherein at least one of the projections functionally engages and seals against the first face of the array of tubes.

Another aspect of the present disclosure includes wherein at least one of the projections defines a gap between the at least one of the projections and the first face of the array of tubes.

Another aspect of the present disclosure includes wherein the projections comprise two outer projections and a center projection therebetween.

Another aspect of the present disclosure includes wherein in the first multi-pass flow pattern configuration the two outer projections are adapted for length to define a gap between respective outer projections and the first face of the array of tubes, and wherein the center projection creates a fluidic seal against the first face of the array of tubes.

Another aspect of the present disclosure includes wherein in the second multi-pass flow pattern configuration the center projection is adapted for length to define a gap between the center projection and the first face of the array of tubes, and wherein the two outer projections each fluidically seals against the first face of the array of tubes.

Another aspect of the present disclosure includes wherein the plate further comprises a partition thereon that extends into the space and fluidically seals against the second face of the array of tubes, the partition being aligned substantially in parallel with the center projection on the bonnet.

Another aspect of the present disclosure includes wherein the array of tubes defines a space between the second face and an interior surface of the elongated body, the plate being detachably coupled to the second face between the interior surface and the second face.

Another aspect of the present disclosure includes wherein the bonnet further comprises a fluid inlet and a fluid outlet for the second fluid.

Another aspect of the present disclosure further comprises the heat exchanger being in functional communication with a compressor.

Another aspect of the present disclosure includes a heat exchanger comprising a shell body having an interior region, a tube bundle having an array of tubes, the tube bundle being configured in the interior region, the tube bundle having a first end and a second end, a modular bonnet adapted to detachably couple to the first end of the tube bundle and establish fluidic communication between the modular bonnet and the array of tubes, and a reversing plate adapted to detachably couple to the second end of the tube bundle and establish fluidic communication between the reversing plate and the array of tubes, wherein the modular bonnet comprises integral partitions on an interior surface thereof, the integral partitions being adaptable for length between a first adjusted configuration and a second adjusted configuration, and wherein the reversing plate comprises a first configuration and a second configuration corresponding to the first adjusted configuration and the second adjusted configuration of the modular bonnet, respectively.

Another aspect of the present disclosure includes wherein the first adjusted configuration comprises two outer partitions of the integral partitions being adjusted for length to define a gap between each of the two outer partitions and the first end of the tube bundle, a center partition of the integral partitions being positioned between the two outer integral partitions and configured to fluidically seal against the first end of the tube bundle, and the first configuration of the reversing plate having a substantially smooth interior surface in fluidic communication with the array of tubes.

Another aspect of the present disclosure includes wherein the second adjusted configuration comprises two outer partitions of the integral partitions being configured to fluidically seal against the first face of the tube bundle, and a center partition of the integral partitions being positioned between the two outer partitions and adjusted for length to define a gap between the center partition and the first end of the tube bundle; and the second configuration of the reversing plate defining a reversing partition on a substantially smooth interior surface, the interior surface being in fluidic communication with the array of tubes, the reversing partition being configured to fluidically seal against the second end of the tube bundle and aligned substantially in parallel with the center partition.

Another aspect of the present disclosure includes a method of assembling a shell and tube type heat exchanger, the method comprising providing a shell body defining a cavity, configuring an array of tubes within the cavity, providing a modular bonnet having a plurality of interior projections each extending a respective length from an interior surface, adjusting the respective length of at least a first projection of the plurality of interior projections and leaving intact the respective lengths of remaining projections of the plurality of interior projections, and coupling the modular bonnet to the array of tubes to place the interior surface of the modular bonnet in fluidic communication with the array of tubes, wherein the at least first projection defines a gap between the at least first projection and the array of tubes and each of the remaining projections fluidically seals against the array of tubes.

Another aspect of the present disclosure further comprises coupling a corresponding reversing plate to the array of tubes.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1A is a side perspective view of an illustrative embodiment of a multi-pass heat exchanger in accordance with the present disclosure.

FIG. 1B is a partially exploded, cut-away, side perspective view of an illustrative embodiment of a multi-pass heat exchanger in accordance with the present disclosure.

FIG. 2 is top cross-sectional view of an illustrative embodiment of a multi-pass heat exchanger in accordance with the present disclosure.

FIG. 3 is a perspective view of a component of an illustrative embodiment of a multi-pass heat exchanger in accordance with the present disclosure.

FIG. 4 is a perspective view of a component of an illustrative embodiment of a multi-pass heat exchanger in accordance with the present disclosure.

FIG. 5A is a top cross-sectional view of an illustrative embodiment of a multi-pass heat exchanger in accordance with the present disclosure.

FIG. 5B is a perspective view of a component of the embodiment of the multi-pass heat exchanger of FIG. 5A, in accordance with the present disclosure.

FIG. 5C is a perspective view of a component of the embodiment of the multi-pass heat exchanger of FIG. 5A, in accordance with the present disclosure.

FIG. 5D is a detail view of the components of the embodiment of the multi-pass heat exchanger within the circle D of FIG. 5A, in accordance with the present disclosure.

FIG. 6A is a top cross-sectional view of an illustrative embodiment of a multi-pass heat exchanger in accordance with the present disclosure.

FIG. 6B is a perspective view of a component of the embodiment of the multi-pass heat exchanger of FIG. 6A, in accordance with the present disclosure.

FIG. 6C is a perspective view of a component of the embodiment of the multi-pass heat exchanger of FIG. 6A, in accordance with the present disclosure.

FIG. 6D is a detail view of the components of the embodiment of the multi-pass heat exchanger within the circle D of FIG. 6A, in accordance with the present disclosure

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

The drawings depict illustrative embodiments of a variable-pass, or multi-pass, heat exchanger 10. These embodiments may each comprise various structural and functional components that complement one another to provide the unique functionality and performance of the heat exchanger 10, the particular structure and function of which will be described in greater detail herein.

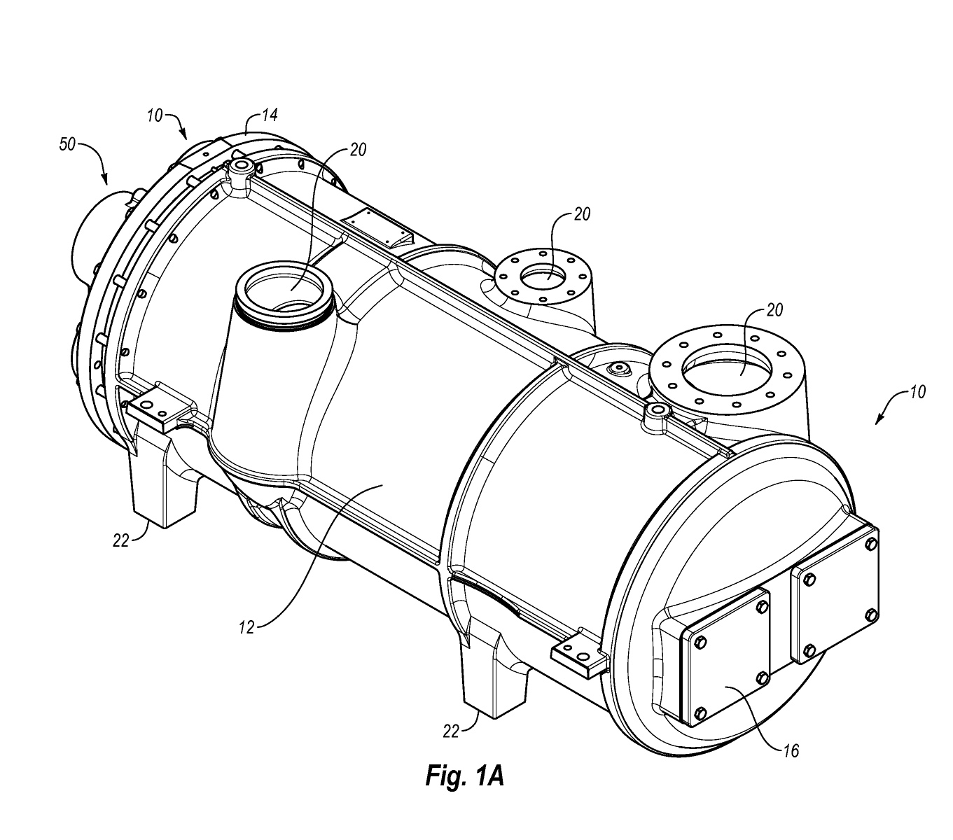

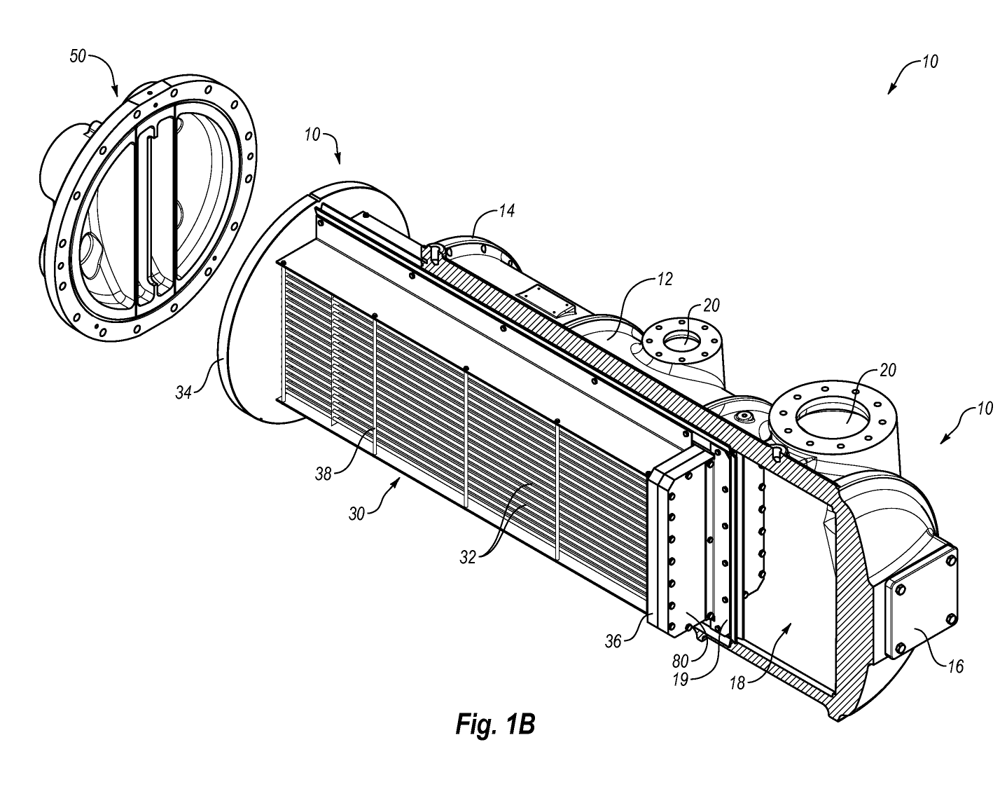

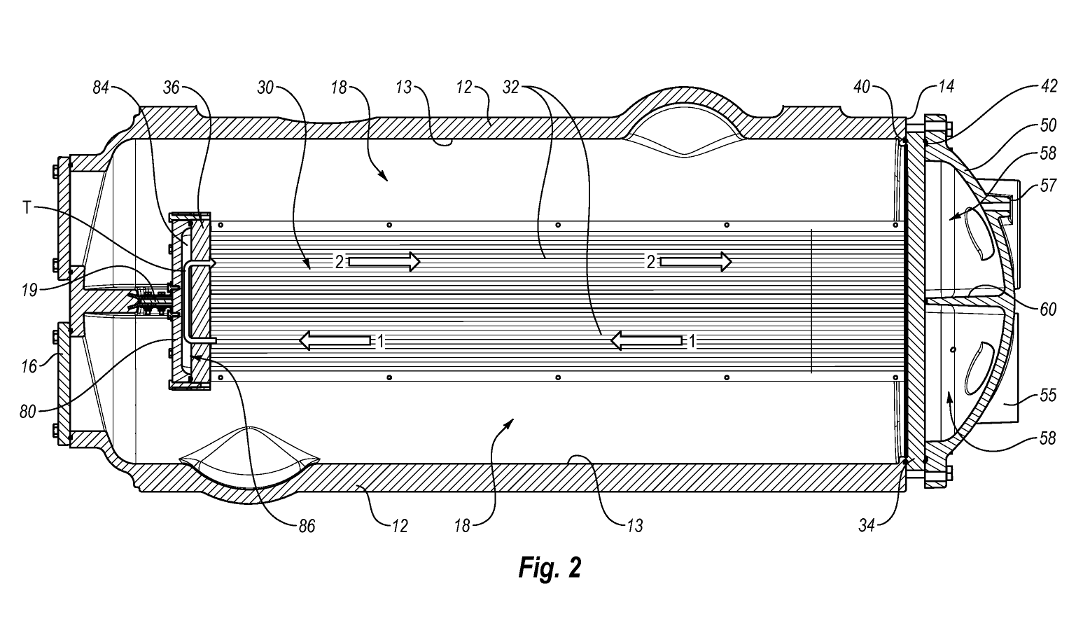

Referring to the drawings, FIGS. 1A, 1B and 2 depict an illustrative embodiment of a heat exchanger 10. Embodiments of the heat exchanger 10 may comprise a shell, manifold, or elongated body 12 having a first end 14 and a second end 16. The elongated body 12 may further define therein a shell chamber or cavity 18. The shell chamber or cavity 18 may be defined by an interior side surface 13 of the elongated body 12. The cavity 18 may extend a partial length of the elongated body 12 from first end 14 to second end 16. The cavity 18 may alternatively extend for substantially the full length of the elongated body 12 from the first end 14 to the second end 16, as shown in the illustrated embodiment. The elongated body 12 may further comprise one or more process fluid inlet/outlet ports 20, whereby a process fluid may enter into the cavity 18 of the elongated body 12 through one or more of the ports 20 and thereafter exit the cavity 18 by one or more of the ports 20, according to manufacturer/design recommendations. The elongated body 12 may further comprise one or more mounting surfaces 22, whereby the elongated body 12 and thus the heat exchanger 10 may be mounted, braced, joined, fixed, or otherwise coupled to, so as to functionally engage and communicate with, another operative body, such as a compressor, including for example a reciprocating, rotary, or centrifugal compressor, whether of a single stage or a multi-stage design.

Referring to FIGS. 1B and 2, embodiments of the heat exchanger 10 may further comprise a tube bundle 30 having a first tube sheet 34 and a second tube sheet 36 and a plurality of tubes or an array of tubes 32 running between the first tube sheet 34 and the second tube sheet 36. The first tube sheet 34 and the second tube sheet 36 may serve to provide end support for each of the tubes in the array of tubes 32. Moreover, the first tube sheet 34 and the second tube sheet 36 may be provided with a plurality of openings in axial alignment generally parallel to the longitudinal axis of the shell or elongated body 12. The respective ends of each of the tubes in the array of tubes 32 may have an opening that is aligned with or in fluidic communication with one of the plurality of openings in the first tube sheet 34 and the second tube sheet 36. In this way, a cooling fluid may pass through each of the first tube sheet 34 and the second tube sheet 36 in at least one of the tubes of the array of tubes 32. The tubes in the array of tubes 32 may be supported along their respective lengths by support members 38.

Embodiments of the heat exchanger 10 may further comprise the tube bundle 30 being positioned or configured within the cavity 18 of the heat exchanger 10 such that the array of tubes 32 may also be positioned within the cavity 18. The first end 14 of the shell or elongated body 12 may be open and configured to receive the tube bundle 30. Under the condition, or when, the tube bundle 30 and the array of tubes 32 are inserted within the cavity 18 by way of the open first end 14, the first tube sheet 34 may abut or functionally engage the first end 14. As the tube bundle 30 containing the array of tubes 32 axially advances into the cavity 18, the second tube sheet 36 may approach the interior surface 17 of the second end 16 until the first tube sheet 34 contacts and functionally engages the first end 14. The first tube sheet 34 may be detachably coupled by fasteners, such as bolts or the like, to the first end 14. A sealing member 40, such as an O-ring, gasket, or other mechanical seal, may be inserted or positioned between the first end 14 and the first tube sheet 34 to hermetically seal the first end 14 and the first tube sheet 34 to one another.

Embodiments of the heat exchanger 10 may further comprise the tube bundle 30 with the array of tubes 32 being supported by the second end 16 of the shell or elongated body 12 by way of a bracket or brace 19 in functional engagement with the tube bundle 30 and the second end 16. Alternatively, the bracket or brace 19 may also functionally engage the interior surface 13 of the elongated body 12 to further support the tube bundle 30 and the array of tubes 32 within the cavity 18. With the bracket or brace 19 coupled between the array of tubes 32 and the interior surface 17 of the second end 16, the second tube sheet 36 and the array of tubes 32 are configured at a distance from the interior surface 17 of the second end 16. Such a distance provides additional space for the process fluid to move about the chamber or cavity 18 and around the array of tubes 32. In other words, such a distance provides more flow area for the process fluid to flow, thus reducing the pressure drop through the chamber or cavity 18.

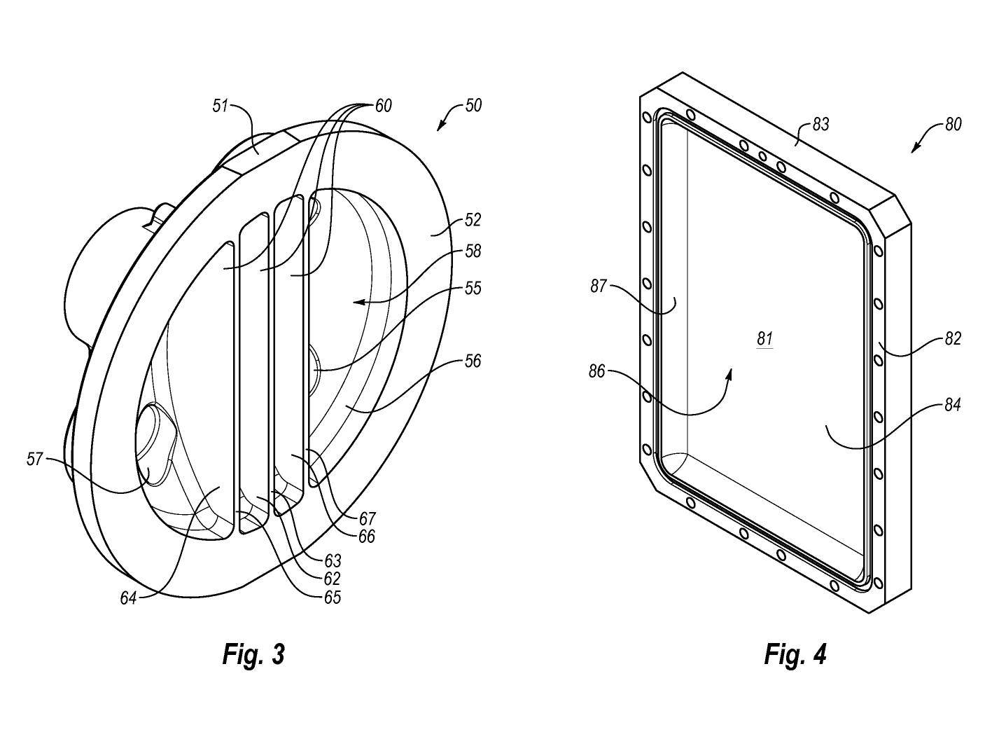

As depicted in FIGS. 2 and 3, embodiments of the heat exchanger 10 may further comprise a bonnet 50. The bonnet 50 may be a substantially domed member having a size (i.e., diameter) and shape to correspond to the size and shape of the first tube sheet 34. The bonnet 50 may further comprise a fluid inlet 55 and a fluid outlet 57 configured therein. The fluid inlet 55 and the fluid outlet 57 may be configured to receive therethrough a cooling fluid, such as water, methanol, ethylene glycol, propylene glycol, combinations thereof, or other fluids that may provide a suitable heat sink. The bonnet 50 may further comprise a flange 51 running about the perimeter of the bonnet 50. The flange 51 may define a face 52, a portion of the face 52 being configured to abut and functionally engage at least a portion of the first tube sheet 34. The bonnet 50 may be configured to detachably couple to the first tube sheet 34. A second sealing member 42, such as an O-ring, gasket, or other mechanical seal, may be positioned between the face 52 and the first tube sheet 34 thereby forming a hermitic seal between the bonnet 50 and the tube bundle 30.

Alternatively, embodiments of the heat exchanger 10 may further comprise the bonnet 50 being configured to functionally engage the elongated body 12 of the heat exchanger 10 at the first end 14 thereof, with the first tube sheet 34 being positioned therebetween. In other words, the tube bundle 30 may be inserted within the cavity 18 until the first tube sheet 34 engages the elongated body 12, with the sealing member 40 therebetween. Thereafter, the bonnet 50 may be functionally coupled to the elongated body 12, by fastening means 46, with the first tube sheet 34 pressed between the bonnet 50 and the elongated body 12. The second sealing member 42 may be positioned between the first tube sheet 34 and the face 52 of the bonnet 50 so as to hermetically seal the bonnet 50 to the first tube sheet 34. In this way, the first tube sheet 34 is held in place between the elongated body 12 and the bonnet 50 and is hermetically sealed to the elongated body 12 and the bonnet 50 by the bonnet 50 being functionally and detachably coupled to the elongated body 12 by fastening means 46. Fastening means 46, or other fastening means in the present disclosure, may be for example, bolts, welds, adhesives, or other known fastener.

The bonnet 50 may further comprise an interior surface 56 that defines an interior region 58 of the bonnet 50. The fluid inlet 55 and the fluid outlet 57 may be configured to pass completely through the bonnet 50 to permit the cooling fluid to enter into and exit out of the interior region 58. With the bonnet 50 being hermetically sealed to the first tube sheet 34, the interior region 58 may be placed in fluidic communication with the tubes of the array of tubes 32. In this way, the bonnet 50 may be configured to direct, or otherwise influence, the flow of cooling fluid into and through the tubes of the array of tubes 32.

Embodiments of the bonnet 50 may further comprise a baffle, partition, or projection 60 extending from the interior surface 56 and into the interior region 58. Embodiments of the bonnet 50 may further comprise the projection 60 being configured to extend from the interior surface 56 in a direction substantially parallel to the horizontal configuration of the array of tubes 32 of the tube bundle 30. Embodiments of the bonnet 50 may further comprise a distal tip portion of the projection 60 being configured to abut, or otherwise functionally engage, the first sheet member 34 to fluidically seal against the first sheet member 34. By sealing against the first sheet member 34, the projection 60 may serve to fluidically divide the interior region 58 into one or more fluid transfer zones, including for example inlet and exit zones, the fluid transfer zones creating a desired number of cooling fluid passes through the array of tubes 32, to be described in greater detail herein.

As depicted in FIGS. 2 and 4, embodiments of the heat exchanger 10 may further comprise a reversing plate or plate member 80. The plate member 80 may have a size and shape to correspond to the second tube sheet 36, such as a substantially rectangular shape as illustrated. The plate member 80 may further comprise a first side 81 and a second side 83. The plate member 80 may further comprise a flanged rim 82 running about the perimeter of the plate member 80 and protruding from the first side 81. The configuration of the flanged rim 82 and the first side 81 may define an interior surface 84 in the first side 81 bordered by the rim 82. The configuration of the flanged rim 82 with respect the interior surface 84 may define a space 86 about the size and shape of the interior surface 84 and to a depth about the size of the flanged rim 82. The flanged rim 82 may further define a face 85, a portion of the face 85 being configured to abut and functionally engage at least a portion of the second tube sheet 36. The flanged rim 82 may further comprise a concave lip 87 positioned between the interior surface 84 and the face 85. In other words, the concave lip 87 may run from off the interior surface 84 up toward the face 85.

The plate member 80 may be configured to detachably couple to the second tube sheet 36 by fastening means that mechanically engage the flanged rim 82 and the second tube sheet 36. A third sealing member 44, such as an O-ring, gasket, or other mechanical seal, may be positioned between the face 85 and the second tube sheet 36 to hermitically seal the plate member 80 to the tube bundle 30. With the plate member 80 being hermetically sealed to the second tube sheet 36, the space 86 may be placed in fluidic communication with the tubes of the array of tubes 32. In this way, the plate member 80 may be configured to direct, or otherwise influence, the flow of cooling fluid into and through the tubes of the array of tubes 32, to be described in greater detail herein.

In operation, the plate member 80 and the bonnet 50 may serve to direct the flow of cooling fluid through the array of tubes 32 and thus through the heat exchanger 10 to draw heat out of and away from the process fluid that may enter the chamber or cavity 18 of the heat exchanger 10 from another operational unit, such as a compressor. For example, the process fluid may be introduced into the cavity 18 at an elevated first temperature. The process fluid may pass in and around the tube bundle 30 and the individual tubes in the array of tubes 32 to transfer heat to the cooling fluid passing through the array of tubes 32. The elevated first temperature of the process fluid is thus lowered to a reduced second temperature as the process fluid flows through the cavity 18. The process fluid, now having a second temperature that is lower than the first temperature, is subsequently discharged from the cavity 18 of the heat exchanger 10. To effectuate this desired heat exchange, the cooling fluid may enter the heat exchanger 10 via the fluid inlet 55 in the bonnet 50. The cooling fluid may thereafter be directed into the array of tubes 32 via the interior region 58 and the protrusion 60. In other words, the cooling fluid that enters one of the fluid transfer regions defined by the interior region 58 and the protrusion 60, by way of the fluid inlet 55, may abut the protrusion 60 and may be forced by pressure into the tube openings of the tubes at the first tube sheet 34 that are in fluidic communication with the fluid transfer region defined by interior region 58 and the protrusion 60.

Once inside these tubes, the cooling fluid may flow the length of the array of tubes 32, as indicated by the arrow 1 (as in pass 1) in FIG. 2, and exit out of the openings of the tubes at the second tube sheet 36. With the space 86 of the plate member 80 being in fluidic communication with the array of tubes 32, the space 86 may receive the cooling fluid and direct it back into any remaining tube openings at the second tube sheet 36 that do not have cooling fluid currently exiting therefrom. In other words, the space 86 may be configured to redirect the flowing cooling fluid back into any available tube openings at the second tube sheet 36, as indicated by arrow T (as in turn) in FIG. 2. Once back inside the tubes, the cooling fluid may flow back toward the first tube sheet 34, as indicated by the arrow 2 (as in pass 2). As the cooling fluid exits the tubes at the first tube sheet 34, the cooling fluid again enters the interior region 58, only to thereafter exit the heat exchanger 10 via the fluid outlet 57 in the bonnet 50. The partition 60 may therefore serve to prevent the cooling fluid that enters the interior region 58 at the fluid inlet 55 from mixing with the cooling fluid that exits the interior region 58 at the fluid outlet 57. In this way, the low temperature of the cooling fluid entering the heat exchanger 10 is not mixed with the high temperature of the cooling fluid exiting the heat exchanger 10, as such mixing would minimize, if not significantly reduce or even eliminate, the heat exchange efficiency of the heat exchanger 10. Moreover, the temperature of the cooling fluid entering the heat exchanger 10 may be substantially cooler than the temperature of the process fluid entering the same heat exchanger 10. Indeed, the greater the temperature difference, the greater the heat exchange.

With reference again to FIG. 3, embodiments of the heat exchanger 10 may further comprise a modular bonnet 50 having a plurality of projections 60 configured to extend from the interior surface 56 and into the interior region 58. The projections 60 may each have an original length from the interior surface 56 to a distal end. For example, one of the projections 60 may be a center partition 62 having a length L from the interior surface 56 to a distal tip end 63. Further in example, another of the projections 60 may be a first outer partition 64 having a length M from the interior surface 56 to a distal tip end 65. Further in example, another of the projections 60 may be a second outer partition 66 having a length N from the interior surface 56 to a distal tip end 67. Embodiments of the modular bonnet 50 may comprise each of the partitions 62, 64 and 66 having a respective length L, M and N such that the respective distal tip ends 63, 65 and 67 terminate at the same plane—the plane defined by the face 52 of the modular bonnet 50.

Embodiments of the modular bonnet 50 may further comprise the partitions 62, 64 and 66 being formed integrally with the bonnet 50, such that partitions 62, 64 and 66 are original to the modular bonnet 50. As such, in this original manufactured condition and under the condition, or when, the modular bonnet 50 is detachably coupled to the first tube sheet 34 in this original condition, each of the partitions 62, 64 and 66 may functionally engage the first tube sheet 34 to hermetically seal against the first tube sheet 34. Embodiments of the modular bonnet 50 may comprise the center partition 62 being configured substantially in the center of the modular bonnet 50 (i.e., the center partition 62 traversing the center of the diameter of the bonnet 50). Embodiments of the modular bonnet 50 may comprise the first and second outer partitions 64 and 66 being substantially equidistant from the center partition 62 on either side of the center partition 62.

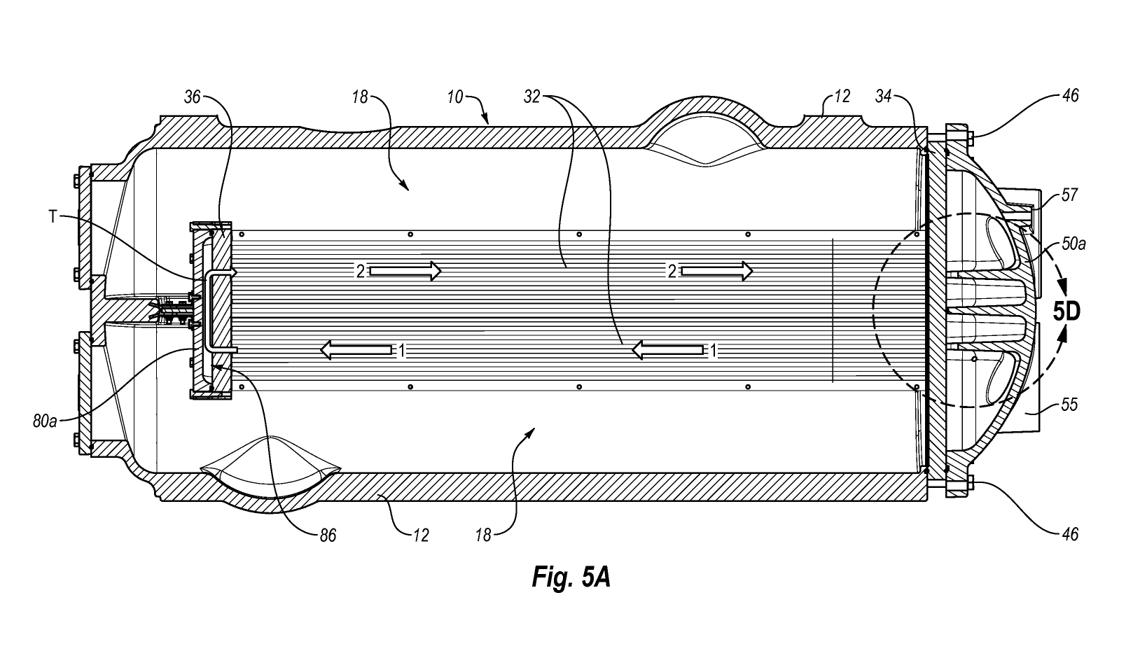

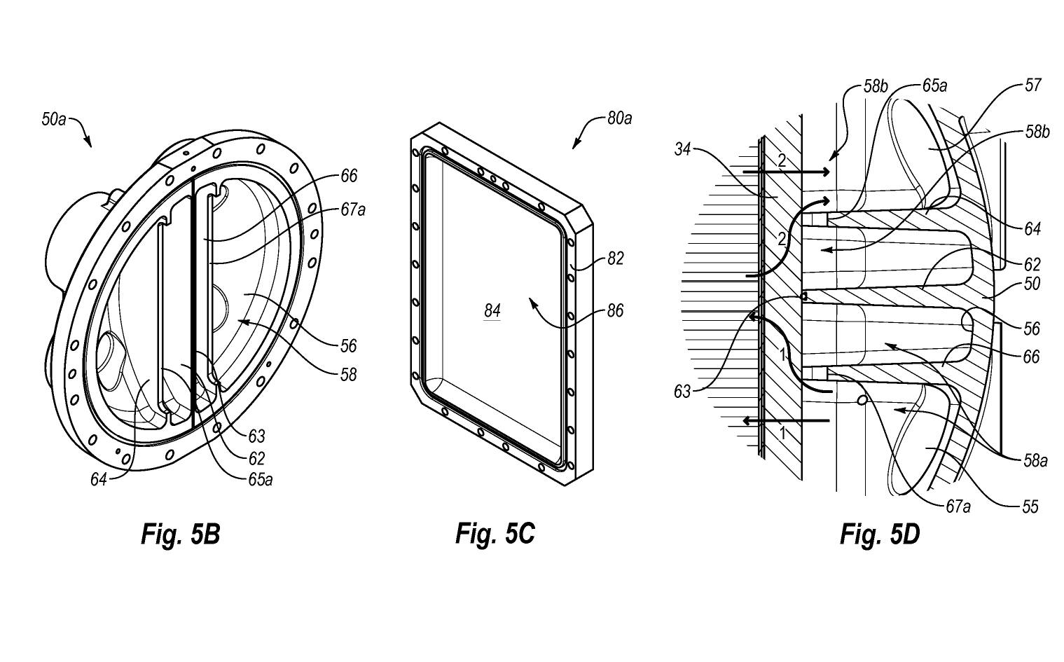

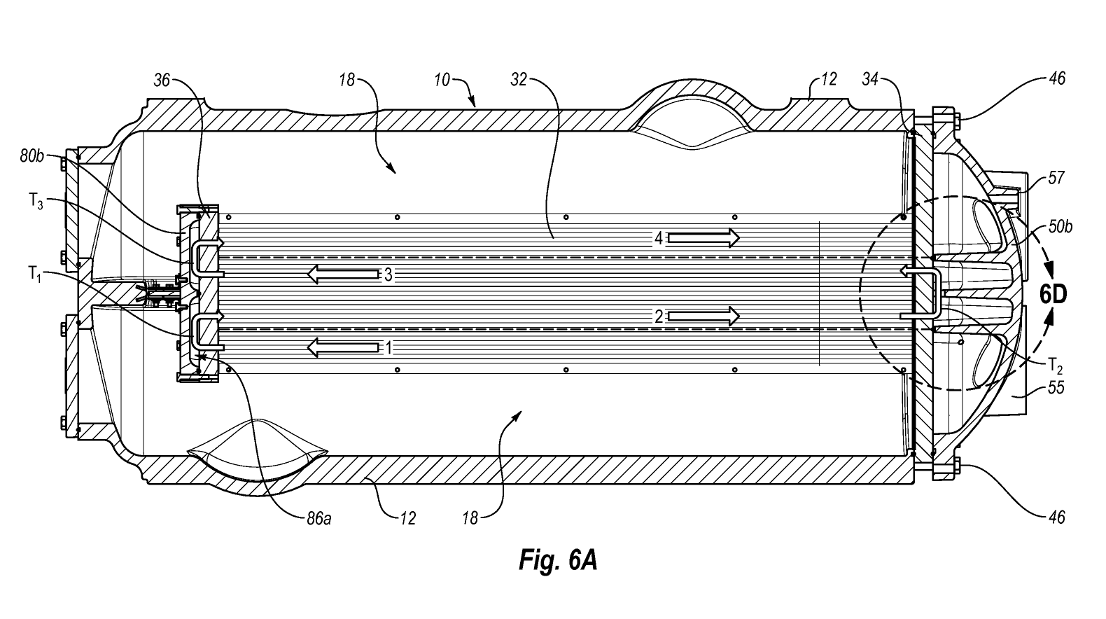

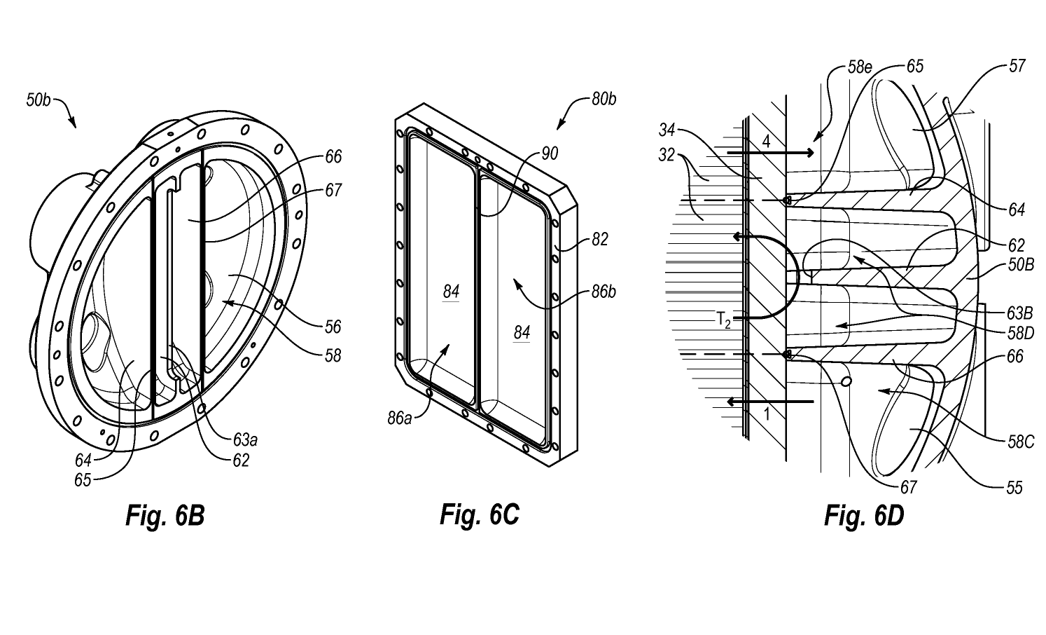

With reference to FIGS. 5A-5D and 6A-6D, embodiments of the heat exchanger 10 may further comprise the modular bonnet 50 and plate member 80 being adapted, adjusted, modified, changed, altered or otherwise configured from an initial configuration to either a first flow configuration or a second flow configuration, or stated another way from the initial configuration to a first flow pattern configuration or a second flow patter configuration. For example, as depicted in FIGS. 5A-5D a modular bonnet 50 may be adapted, adjusted, modified, changed, altered or otherwise configured from modular bonnet 50 to modular bonnet 50a and a plate member 80 may be adapted, adjusted, modified, changed, altered or otherwise configured as a corresponding plate member 80a to functionally engage the tube bundle 30 to comprise a first multi-pass flow configuration of the heat exchanger 10. The modular bonnet 50 may be permanently adapted, adjusted, modified, changed, altered or otherwise configured to modular bonnet 50a. Further in example, as depicted in FIGS. 6A-6D a modular bonnet 50 may be adapted, adjusted, modified, changed, altered or otherwise configured as modular bonnet 50b and a plate member 80 may be adapted, adjusted, modified, changed, altered or otherwise configured as a corresponding plate member 80b to functionally engage the tube bundle 30 to comprise a second multi-pass flow configuration of the heat exchanger 10. The modular bonnet 50 may be permanently adapted, adjusted, modified, changed, altered or otherwise configured to modular bonnet 50b.

As depicted in FIGS. 5A-5D, illustrative embodiments of the heat exchanger 10 may comprise the modular bonnet 50a having a center partition 62 configured substantially in the center of the modular bonnet 50a. The modular bonnet 50a may further comprise the length L of the center partition 62 remaining unaltered from its initial length L, whereas length, M and N, respectively, of each of the first and second outer partitions 64 and 66 may be adapted, adjusted, modified, or otherwise configured to reduce the respective length, M and N, thereof. As such, under the condition the modular bonnet 50a is detachably coupled to the first tube sheet 34, as described herein, the center partition 62 may functionally engage the first tube sheet 34 without the first and second outer partitions 64 and 66 functionally engaging the first tube sheet 34. A sealing member 48 may be positioned between the distal end 63 of the center partition 62 and the first tube sheet 34 to hermetically seal the center partition 62 to the first tube sheet 34. The center partition 62 may therefore partition the interior region 58 into two fluid transfer zones to effectively divide the tubes in the array of tubes 32 into a substantially equal number, while the first and second outer partitions 64 and 66 remain functionally dormant within the interior region 58 because they do not engage the first tube sheet 34. For example, embodiments of the tube bundle 30 may comprise 288 individual tubes. Accordingly, the center partition 62 may be configured on the bonnet 50a to abut the first tube sheet 34 of the tube bundle 30 at a point on the first tube sheet 34 to effectively divide the first tube sheet 34 as well as the interior region 58 into two halves, a first half 58a in functional communication with 144 of the 288 tubes and a second half 58b in functional communication with the remaining 144 of the 288 tubes. Further in example, the lengths M and N may be reduced by 25 mm, such that there is an opening of 25 mm between each of the distal tip ends 65a and 67a, of the first outer partition 64 and the second outer partition 66, respectively, and the first tube sheet 34. Lengths M and N may be altered by removing material from the distal tip ends 65a and 67a by machining, grinding, cutting, bending, drilling, or other known method. Lengths M and N may be permanently altered for length once the material is removed from the distal tip ends 65a and 67a.

Under the condition the modular bonnet 50a is coupled to the first tube sheet 34, the corresponding plate member 80a may be coupled to the second tube sheet 36. In this manner, as depicted in the illustrative example of FIGS. 5A and 5D, the heat exchanger 10 may operate in a two-pass configuration. The cooling fluid may enter the bonnet 50a via the fluid inlet 55 to thereby enter the tubes of the array of tubes 32 that are in fluidic communication with the interior region 58a as indicated by arrows 1 in FIG. 5D. As depicted, portions of the cooling fluid may pass by the second outer partition 66 through the opening between the distal end 67a and the first tube sheet 34. The cooling fluid may then pass through the array of tubes 32 as indicated by the arrow 1 in FIG. 5A, exit the array of tubes 32, enter the space 86, and be redirected by the space 86 back into the remaining tubes of the array of tubes 32 as indicated by the arrow T in FIG. 5A. The cooling fluid may then pass again through the array of tubes 32 as indicated by the arrow 2 in FIG. 5A and exit the array of tubes 32 into the interior region 58b, as indicated by the arrows 2 in FIG. 5D. As depicted, portions of the cooling fluid may pass by the first outer partition 64 through the opening between the distal end 65a and the first tube sheet 34. Thereafter, the cooling fluid may exit the bonnet 50a via the fluid outlet 57.

As depicted in FIGS. 6A-6D, illustrative embodiments of the heat exchanger 10 may comprise the modular bonnet 50b having a center partition 62 configured substantially in the center of the modular bonnet 50b. Embodiments of the modular bonnet 50b may comprise the first and second outer partitions 64 and 66 being configured on the modular bonnet 50b substantially equidistant from the center partition 62. The modular bonnet 50b may further comprise the length M and N, of the first and second outer partitions, 64 and 66, respectively, remaining unaltered from their initial respective lengths, M and N, whereas the length L of the center partition 62 may be adapted, adjusted, modified, or otherwise configured to reduce the length L thereof. As such, under the condition the modular bonnet 50b is detachably coupled to the first tube sheet 34, as described herein, the first and second outer partitions 64 and 66 may functionally engage the first tube sheet 34 without the center partition 62 functionally engaging the first tube sheet 34. A sealing member 49 may be positioned between the distal ends 65 and 67 of the first and second outer partitions 64 and 66, respectively, to hermetically seal each of the first and second outer partitions 64 and 66 to the first tube sheet 34. The first and second outer partitions 64 and 66 may therefore divide the tubes in the array of tubes 32 into functional groups of a substantially equal number of tubes, with the help of the corresponding plate member 80b, to be discussed in greater detail herein. Because the adjusted length L of the center partition 62 does not contact the first tube sheet 34, the center partition 62 may remain functionally dormant within the interior region 58. For example, embodiments of the tube bundle 30 may comprise 288 individual tubes. Accordingly, the first and second outer partitions 64 and 66 may be positioned and configured on the bonnet 50b to abut the first tube sheet 34 of the tube bundle 30 at points on the first tube sheet 34 to effectively divide interior region 58 into three regions, a first region 58c in functional communication with about 72 of the 288 tubes, a second region 58d in functional communication with about 144 tubes of the 288 tubes, and a third region 58c in functional communication with the remaining about 72 of the 288 tubes. Further in example, the length L may be reduced by about 25 mm, such that there is an opening of 25 mm between the distal tip end 63b of the center partition 62 and the first tube sheet 34. Length L may be altered by removing material from the distal tip end 63b by machining, grinding, cutting, bending, drilling, or other known method. Length L may be permanently altered for length once the material is removed from the distal tip end 63b.

Embodiments of the heat exchanger 10 may further comprise a corresponding plate member 80b that corresponds to the modular bonnet 50b. The plate member 80b may comprise the features of plate member 80 and further comprise a reversing partition 90 configured on the interior surface 84 of the plate member 80b. The reversing partition 90 may rise, or otherwise extend, from the interior surface 84 to a height or distance equal to the height of the face 85 of the flanged rim 82. As such, under the condition the plate member 80b is detachably coupled to the second tube sheet 36, the face 85 and the reversing partition 90 each functionally engage the second tube sheet 36. Further a sealing member 45 may be inserted between the face 85, the reversing partition 90 and the second tube sheet 36 to hermetically seal the plate member 80b against the second tube sheet 36. The reversing partition may be configured to divide the space 86 of the plate member 80b into two substantially equal halves, 86a and 86b, as depicted in FIG. 6C. The reversing partition 90 may be configured on the plate member 80b in a substantially parallel orientation with the partitions 62, 64 and 66 on the modular bonnet 50b. Moreover, the reversing partition 90 may be aligned with the center partition 62 along an axial plane.

Under the condition the modular bonnet 50b is coupled to the first tube sheet 34, the corresponding plate member 80b may be coupled to the second tube sheet 36. In this manner, as depicted in the illustrative example of FIGS. 6A and 6D, the heat exchanger 10 may operate in a four-pass configuration. The cooling fluid may enter the modular bonnet 50b via the fluid inlet 55 and thereafter enter the tubes of the array of tubes 32 that are in fluidic communication with the interior region 58c, as indicated by arrow 1 in FIG. 6D. As depicted, the cooling fluid abuts the second outer partition 66 and enters the array of tubes 32. The cooling fluid may then pass through the array of tubes 32 as indicated by the arrow 1 in FIG. 6A, exit the array of tubes 32, enter the first space 86a, abut the reversing partition 90 and be redirected into the remaining tubes of the array of tubes 32 in fluidic communication with the space 86a, as indicated by the arrow T₁ in FIG. 6A. The cooling fluid may then pass again through the array of tubes 32 as indicated by the arrow 2 in FIG. 6A and exit the array of tubes 32 into the interior region 58d. As depicted by the arrow T₂ in FIG. 6D, the cooling fluid may pass by the center partition 62 through the opening between the distal end 63b and the first tube sheet 34. Thereafter, the cooling fluid may be redirected into the remaining tubes of the array of tubes 32 in fluidic communication with the interior region 58d, as indicated by the arrow T₂ in FIG. 6D, and pass back through the array of tubes 32, as indicated by the arrow 3 in FIG. 6A. The cooling fluid may then exit the array of tubes 32, enter the second space 86b and be redirected by the second space 86b into the remaining tubes of the array of tubes 32 in fluidic communication with the space 86b, as indicated by the arrow T₃ in FIG. 6A. The cooling fluid may then pass again through the array of tubes 32 as indicated by the arrow 4 in FIG. 6A and exit the array of tubes 32 into the interior region 58e. The cooling fluid may thereafter exit the bonnet 50b via the fluid outlet 57.

Embodiments of the heat exchanger 10 may further comprise the modular bonnet 50a and the corresponding plate member 80a being coupled to the first and second faces 34 and 36, respectively, of the array of tubes 30 in a first partition configuration to function as a set to establish a 2-pass configuration, wherein the cooling fluid that passes through the tubes 32 makes two passes along the entire axial length of the array 30. In other words, in this first partition configuration the modular bonnet 50a brings partition 62 into fluidic communication with the first tube sheet 34 to influence the flow pattern of the cooling fluid through the array of tubes 30. In particular, with the partition 62 in functional engagement with the first tube sheet 34, the cooling fluid makes the first pass from the first tube sheet 34 to the second tube sheet 36 and then the second pass from the second tube sheet 36 back to the first tube sheet 34. In embodiments of the heat exchanger 10, the flow rate of the cooling fluid within the array of tubes in the 2-pass configuration to be about 298 gallons per minute (gpm).

Embodiments of the heat exchanger 10 may further comprise the modular bonnet 50b and the corresponding plate member 80b being coupled to the first and second faces 34 and 36, respectively, of the array of tubes 30 in a second partition configuration to function as a set to establish a 4-pass configuration, wherein the cooling fluid that passes through the tubes 32 makes four passes along the entire axial length of the array 30. In other words, in this second partition configuration the modular bonnet 50b brings partitions 64 and 66 into fluidic communication with the first tube sheet 34 to influence the flow pattern of the cooling fluid through the array of tubes 30. In particular, with the partitions 64 and 66 in functional engagement with the first tube sheet 34, the cooling fluid makes the first pass from the first tube sheet 34 to the second tube sheet 36, the second pass from the second tube sheet 36 back to the first tube sheet 34, the third pass from the first tube sheet 34 back to the second tube sheet 36, and the fourth pass from the second tube sheet 36 back to the first tube sheet 34. In embodiments of the heat exchanger 10, the flow rate of the cooling fluid within the array of tubes in the 4-pass configuration may be about 149 gallons per minute (gpm).

Embodiments of the heat exchanger 10 may further comprise the set of the modular bonnet 50a and the corresponding plate member 80a and the set of the modular bonnet 50b and the corresponding plate member 80b being interchangeable sets with one another on the heat exchanger 10 to adjust the number of cooling fluid passes within the array of tubes 30. In other words, if one desires to have the heat exchanger 10 provide two passes of the cooling fluid through the array of tubes 30 within the cavity 18, one need only couple the set of the modular bonnet 50a and the corresponding plate member 80a to the first and second faces 34 and 36, respectively, as described herein. In like manner, if one desires to have the heat exchanger 10 provide four passes of the cooling fluid through the array of tubes 30 within the cavity 18, one need only couple the set of the modular bonnet 50b and the corresponding plate member 80b to the first and second faces 34 and 36, respectively, as described herein. In this manner, the heat exchanger 10 may be outfitted to function as either a 2-pass heat exchanger or a 4-pass heat exchanger, as needed, desired, or as determined by regional requirements.

Embodiments of the heat exchanger 10 may provide the advantage that the heat exchanger 10 may be configured for different regions/parts of the world or for different customer specifications while utilizing the same component parts of the heat exchanger 10, except for the modular bonnet 50 and the corresponding plate member 80, as herein described, that when coupled to the heat exchanger 10 can adapt, modify, change, alter, adjust, or otherwise configure the heat exchanger 10 to a first multi-pass flow pattern configuration or a second multi-pass flow pattern configuration. Due to the common usage of component parts in the heat exchanger 10 between multi-pass configurations (i.e., the same elongated body 12 and array of tubes 32), there is a direct reduction in parts and sub-assemblies over the prior art. A reduction in the number of parts to achieve the same, or substantially similar, performance is an increase in efficiency and a reduction in operational cost.

Including the disclosure of the structure and operation of the heat exchanger 10 set forth above, embodiments of the heat exchanger 10 may comprise a method of assembling and/or operating the heat exchanger 10. The method may include providing a shell body defining a cavity and configuring an array of tubes within the cavity. The method may further comprise providing a modular bonnet having a plurality of interior projections each extending a respective length from an interior surface. The method may further comprise determining the desired flow patter configuration, such as a two-pass flow pattern configuration or a four-pass flow configuration. The method may further comprise adjusting the respective length of at least a first projection of the plurality of interior projections and leaving intact the respective lengths of remaining projections of the plurality of interior projections to modify the flow pattern configuration of the bonnet. The method may further comprise coupling the modified modular bonnet to the array of tubes to place the interior surface of the modified bonnet in fluidic communication with the array of tubes, wherein the at least first projection defines a opening between the at least first projection and the array of tubes and each of the remaining projections fluidically seals against the array of tubes. The method may further comprise detachably coupling a plate member to the array of tubes on an opposing side of the array of tubes from the modified modular bonnet.

The method may further comprise the leaving the length of the center partition unaltered from its initial length, and adapting, adjusting, modifying, shortening or otherwise configuring the length of each of the first and second outer partitions and to reduce the respective lengths thereof. The method may further comprise detachably coupling the modified bonnet to the array of tubes, such that the center partition functionally engages the first tube sheet of the array of tubes without the first and second outer partitions functionally engaging the first tube sheet. Doing so may provide that the center partition divides the tubes in the array of tubes in a substantially equal number while the first and second outer partitions remain functionally dormant within the interior region of the modified bonnet.

The method may further comprise detachably coupling the modular bonnet to the first tube sheet of the array of tubes as well as the corresponding plate member to the second tube sheet of the array of tubes. The method may further comprise introducing the cooling fluid to the modified bonnet to thereby enter the tubes of the array of tubes that are in fluidic communication with the interior region of the modified bonnet. The method may further comprise passing the cooling fluid by the second outer partition through the opening between the distal end and the first tube sheet. The cooling fluid may then pass through the array of tubes, exit the array of tubes, enter the space of the plate member, and be redirected by the space into the remaining tubes of the array of tubes. The cooling fluid may then be passed pass again through the array of tubes and exit the array of tubes into the interior region of the modified bonnet. The method may further comprise passing portions of the cooling fluid by the first outer partition through the opening between the distal end and the first tube sheet. Thereafter, the cooling fluid may exit the modified bonnet.

The method may further comprise leaving the length of the first and second outer partitions unaltered from their initial respective lengths and adapting, adjusting, modifying, shortening or otherwise configuring the length of the center partition to reduce the length thereof. The method may further comprise detachably coupling the modified bonnet to the first tube sheet of the tube array such that the first and second outer partitions may functionally engage the first tube sheet without the center partition functionally engaging the first tube sheet. The first and second outer partitions may therefore divide the interior region into a first region, a second region, and a third region. The method may further comprise providing a corresponding plate member having a reversing partition configured on the interior surface of the plate member. The plate member may be detachably coupled to the second tube sheet to functionally engage the second tube sheet. The method may further comprise dividing the space of the plate member into two substantially equal halves by the reversing partition, the first space and the second space. The method may further comprise detachably coupling the modified bonnet to the first tube sheet and the corresponding plate member to the second tube sheet. Thereafter, a cooling fluid can be introduced into the heat exchanger to enter the modified bonnet via the fluid inlet and thereafter enter the tubes of the array of tubes that are in fluidic communication with the first interior region. The method may further comprise passing the cooling fluid through the array of tubes and exiting the array of tubes into the first space. Thereafter, the cooling fluid may be redirected into the remaining tubes of the array of tubes in fluidic communication with the first space. The cooling fluid may then pass again through the array of tubes and exit the array of tubes into the second interior region. The method may further comprise passing by the center partition through the opening between the distal end and the first tube sheet. Thereafter, the cooling fluid may be redirected into the remaining tubes of the array of tubes in fluidic communication with the second interior region and pass back through the array of tubes. The cooling fluid may then exit the array of tubes to enter the second space. The cooling fluid may be redirected by the second space into the remaining tubes of the array of tubes in fluidic communication with the second space. The cooling fluid may then pass again through the array of tubes and exit the array of tubes into the third interior region. The cooling fluid may thereafter exit the modified bonnet.

The materials of construction of the heat exchanger 10 and its various component parts may vary considerably, depending on the temperatures and pressures to which they will be subjected and nature of the fluids with which they will be used. Most commonly, carbon steel will be employed, such as for example SA516 steel. Further, operation under certain conditions may dictate the use of stainless steel, such as the 300 or 400 series, nickel, nickel alloys, nickel-based super allows, copper alloy or the like. The sealing members described herein, such as O-rings, packing, gaskets, or the like may be of rubber, polytetrafluoroethylene, metal, asbestos or other materials known for such purpose.

Furthermore, the components defining the above-described heat exchanger 10 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, 3-D printing, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A shell and tube heat exchanger comprising:
an elongated shell body defining therein a cavity configured to receive a first fluid;
an array of tubes having first and second ends and positioned within the cavity to receive and direct a second fluid through the cavity; and
a partition configuration interchangeable with respect to the array of tubes and in fluidic communication therewith to direct a flow pattern of the second fluid,
wherein a first partition configuration establishes a first flow pattern and a second partition configuration establishes a second flow pattern.

2. The heat exchanger of claim 1, the first partition configuration further comprising:
a bonnet detachably coupled to the first end of the array of tubes and having an interior surface defining an interior region;
two outer partitions and a center partition therebetween extending from the interior surface into the interior region,
wherein the two outer partitions are modified for length to define an opening between the array of tubes and each of the outer partitions when the bonnet is coupled to the array of tubes, and
wherein the center partition engages the array of tubes to establish a fluidic seal therewith when the bonnet is coupled to the array of tubes; and
a reversing plate detachably coupled to the second end of the array of tubes and defining a space in fluidic communication with the array of tubes, and
wherein the bonnet and the reversing plate cooperate with the array of tubes to establish a two-pass flow pattern of the second fluid through the array of tubes.

3. The heat exchanger of claim 1, the second partition configuration further comprising:
a bonnet detachably coupled to the first end of the array of tubes and having an interior surface defining an interior region;
two outer partitions and a center partition therebetween extending from the interior surface into the interior region,
wherein the center partition is modified for length to define an opening between the array of tubes and the center partition when the bonnet is coupled to the array of tubes, and
wherein the two outer partitions each engage the array of tubes to establish a fluidic seal therewith when the bonnet is coupled to the array of tubes; and
a reversing plate detachably coupled to the second end of the array of tubes and having a dividing partition defining substantially equal and separate spaces in fluidic communication with the array of tubes, and
wherein the bonnet and the reversing plate cooperate with the array of tubes to establish a four-pass flow pattern of the second fluid through the array of tubes.

4. The heat exchanger of claim 1, further comprising a bonnet having an initial partition configuration, wherein the initial partition configuration is permanently modifiable to form a first modified bonnet having the first partition configuration or a second modified bonnet having the second partition configuration.

5. A shell and tube heat exchanger comprising:
an elongated body defining therein a cavity, the elongated body configured to receive a first fluid into the cavity;
an array of tubes positioned within the cavity and having a first face and a second face, the array of tubes directing a second fluid through the cavity within the array of tubes;
a bonnet detachably coupled to the first face of the array of tubes and defining an interior region in fluidic communication with the array of tubes;
a plate detachably coupled to the second face of the array of tubes and defining a space in fluidic communication with the array of tubes; and
projections extending from an interior surface of the bonnet into the interior region defined by the interior surface, the projections being modifiable to one of a first projection configuration or a second projection configuration;
wherein the first projection configuration establishes a first flow pattern through the array of tubes and the second projection configuration establishes a second flow pattern through the array of tubes.

6. The heat exchanger of claim 5, wherein the first projection configuration establishes two passes of the second fluid through the array of tubes and the second projection configuration establishes four passes of the second fluid through the array of tubes.

7. The heat exchanger of claim 5, wherein the projections are irreversibly modifiable.

8. The heat exchanger of claim 5, wherein the projections comprise two outer projections and a center projection therebetween.

9. The heat exchanger of claim 8, wherein in the first projection configuration the two outer projections are modified for length to define a gap between respective outer projections and the first face of the array of tubes, and wherein the center projection fluidically seals against the first face of the array of tubes.

10. The heat exchanger of claim 8, wherein in the second projection configuration the center projection is modified for length to define a gap between the center projection and the first face of the array of tubes, and wherein the two outer projections each fluidically seals against the first face of the array of tubes.

11. The heat exchanger of claim 10, wherein the plate further comprises a partition thereon that extends into the space and fluidically seals against the second face of the array of tubes to divide the space into substantially equal halves.

12. The heat exchanger of claim 5, wherein the second face of the array of tubes is positioned at a distance from an interior surface of the elongated body, the plate being detachably coupled to the second face between the interior surface and the second face.

13. The heat exchanger of claim 5, further comprising the heat exchanger being in functional communication with a compressor.

14. A multi-pass heat exchanger comprising:
an elongated body defining therein a cavity, the elongated body configured to receive a first fluid into the cavity;
an array of tubes positioned within the cavity and having a first face and a second face, the array of tubes directing a second fluid through the cavity;
a first bonnet adapted to be detachably coupled to the first face of the array of tubes and having a plurality of projections configured to influence the flow of the second fluid;
a first plate adapted to be detachably coupled to the second face of the array of tubes and configured to influence the flow of the second fluid,
a second bonnet adapted to be detachably coupled to the first face of the array of tubes and having a plurality of projections configured to influence the flow of the second fluid; and
a second plate adapted to be detachably coupled to the second face of the array of tubes and configured to influence the flow of the second fluid,
wherein when the first bonnet is coupled to the first face of the array of tubes and the first plate is coupled to the second face of the array of tubes, the second fluid has a first flow pattern, and
wherein when the second bonnet is coupled to the first face of the array of tubes and the second plate is coupled to the second face of the array of tubes, the second fluid has a second flow pattern that is different than the first flow pattern.

15. The heat exchanger of claim 14, wherein the first bonnet comprises two outer projections and a center projection therebetween, wherein each of the outer and center projections extends from an interior surface of the first bonnet into an interior region defined by the interior surface, wherein the center projection engages the first face of the array of tubes to establish a fluidic seal therebetween when the first bonnet is coupled to the first face, and wherein the two outer projections are modified for length to define a gap between each of the outer projections and the first face.

16. The heat exchanger of claim 15, wherein the first plate comprises a space in fluidic communication with the second face of the array of tubes, and wherein the first bonnet and the first plate cooperate with the array of tubes to establish a two-pass flow pattern of the second fluid within the array of tubes.

17. The heat exchanger of claim 14, wherein the second bonnet comprises two outer projections and a center projection therebetween, wherein each of the outer and center projections extends from an interior surface of the second bonnet into an interior region defined by the interior surface, wherein the two outer projections engage the first face of the array of tubes to establish a fluidic seal therebetween when the second bonnet is coupled to the first face, and wherein the center projection is modified for length to define a gap between the center projection and the first face.

18. The heat exchanger of claim 17, wherein the second plate comprises a space in fluidic communication with the second face of the array of tubes and a partition extending into the space that fluidically seals against the second face to divide the space substantially in half, and wherein the second bonnet and the second plate cooperate with the array of tubes to establish a four-pass flow pattern of the second fluid within the array of tubes.

19. A method of assembling a shell and tube type heat exchanger, the method comprising:
providing a shell body defining a cavity;
configuring an array of tubes within the cavity;
providing a modular bonnet having a plurality of interior projections each extending a respective length from an interior surface;
adjusting the respective length of at least a first projection of the plurality of interior projections and leaving intact the respective lengths of remaining projections of the plurality of interior projections; and
coupling the modular bonnet to the array of tubes to establish fluidic communication with the array of tubes, wherein the at least first projection defines a gap between the at least first projection and the array of tubes and each of the remaining projections fluidically seals against the array of tubes.

20. The method of claim 19, further comprising coupling a corresponding reversing plate to the array of tubes.
